(19) United States
(12) Patent Application Publication
(10) Pub. No.: US 2015/0110939 A1
(43) Pub. Date: Apr. 23, 2015

(54) CAMP COOKER APPARATUS AND SYSTEM

(71) Applicant: MAVA LLC dba Campfire Kitchen, Cedar Hills, UT (US)

(72) Inventors: Randy J. Benson, Cedar Hills, UT (US); Lane A. Ekberg, Salt Lake City, UT (US); Shane Rawlings, Alpine, UT (US)

(21) Appl. No.: 14/521,420

(22) Filed: Oct. 22, 2014

Related U.S. Application Data
(60) Provisional application No. 61/894,309, filed on Oct. 22, 2013.

(51) Int. Cl. A47J 37/04

(52) U.S. Cl. CPC A47J 37/049
USPC 426/523; 99/421 A

(57) ABSTRACT

Disclosed herein is one embodiment of a camp cooker system. The camp cooker system includes a handle, an elongate arm that includes a proximal end and a distal end, and a stand. The proximal end of the elongate arm is coupled to the handle and the distal end of the elongate arm is coupleable to one or more food items to support the one or more food items adjacent a heat source. The stand is for supporting, free of a user's supporting force, at least the distal end of the elongate arm a distance above a ground terrain. The stand includes a top end and a bottom end, with the top end being detachably coupled to the elongate arm and the bottom end being engageable with the ground terrain. The engagement of the bottom end with the ground terrain anchors and supports the system.

### CROSS-REFERENCES TO RELATED APPLICATIONS

This application claims the benefit of U.S. Provisional Patent Application No. 61/894,309 entitled “APPARATUS, SYSTEM, AND METHOD FOR CAMP COOKER WITH COOKING STAND” and filed on Oct. 22, 2013 for Lane A. Ekberg, which is incorporated herein by reference.

### FIELD

This invention relates generally to cooking equipment, and more specifically for cooking equipment used over heat sources outside of the home.

### BACKGROUND

Cooking utensils have been used for hundreds, if not thousands, of years and are still heavily used today. There are cooking utensils that are used by outdoor enthusiasts and those looking for a hot cooked meal where conventional ovens, gas fuel and electric power devices are not available. Some of these utensils have proven to be useful when backpacking, camping, or being far away from the usual utilities that cook food and boil water.

### SUMMARY

The subject matter of the present application has been developed in response to the present state of the art, and in particular, in response to the problems and needs associated with camping cooking utensils that have not yet been fully solved by currently available devices. Accordingly, the subject matter of the present application has been developed to provide a camp cooking utensil system that overcomes at least some of the shortcomings of the prior art.

Disclosed herein is one embodiment of a camp cooker system. The camp cooker system includes a handle, an elongate arm that includes a proximal end and a distal end, and a stand. The proximal end of the elongate arm is coupled to the handle and the distal end of the elongate arm is coupleable to one or more food items to support the one or more food items adjacent a heat source. The stand is for supporting, free of a user's supporting force, at least the distal end of the elongate arm a distance above a ground terrain. The stand includes a top end and a bottom end, with the top end being detachably coupled to the elongate arm and the bottom end being engageable with the ground terrain. The engagement of the bottom end with the ground terrain anchors and supports the system.

According to one implementation, the elongate arm may include a telescoping structure for extending and retracting a length of the elongate arm. In such an implementation, the elongate arm may be at least partially retractable within the handle. Additionally, the proximal end of the elongate arm may be detachably coupled to the handle. In any of these implementations, the handle may include a receptacle that has a lock groove and the proximal end of the elongate arm may include a spring coupler that has a lock bar. In order to detachably couple the handle to the elongate arm, the lock bar is positionable in spring-loaded engagement with the lock groove.

In one implementation, the camp cooker system further includes a food attachment that is detachably coupled to the distal end of the elongate arm for supporting the one or more food items. The elongate arm may be rotatable about a longitudinal axis of the elongate arm when the top end of the stand is coupled to the elongate arm. Further, the elongate arm may be pivotable in a horizontal direction about the top end of the stand when the top end of the stand is coupled to the elongate arm. In one implementation, the top end of the stand includes an engagement feature with boreholes so that the elongate arm can be at least partially inserted through the boreholes of the engagement feature.

In one implementation, the handle is actually a first handle and the elongate arm is actually a first elongate arm. In such an implementation, the stand is a second handle that is coupled to a second elongate arm, with the second handle detachably coupled to the first elongate arm and the second elongate arm engageable with the ground terrain to anchor the stand. The first handle and the first elongate arm may be substantially similar to and swappable with the second handle and the second elongate arm.

Further disclosed herein is one embodiment of a camp cooker apparatus. The camp cooker apparatus includes a handle with a receptacle that has a lock groove and an elongate arm with a proximal end and a distal end. In one implementation, the proximal end has a spring coupler with a lock bar and the lock bar may be positionable in spring-loaded engagement with the lock groove of the receptacle to detachably couple the elongate arm to the handle. The distal end is detachably coupled to a food attachment that supports one or more food items adjacent a heat source. The elongate arm also has a telescoping structure for extending and retracting a length of the elongate arm. In one implementation, the elongate arm is at least partially retractable within the handle.

Also disclosed herein is a method for cooking one or more food items over a heat source. The method includes providing a handle, providing an elongate arm that has a proximal end and a distal end, with the proximal end being coupled to the handle, and providing a stand with a top end and a bottom end. The method also includes inserting the bottom end of the stand into the ground terrain, detachably coupling the top end of the stand to the elongate arm, coupling the one or more food items to the distal end of the elongate arm, and positioning the distal end of the elongate arm adjacent the heat source in a cooking position, with the stand supporting the elongate arm in the cooking position without requiring the user to exert a force

According to one implementation, the elongate arm has a telescoping structure for extending and retracting a length of the elongate arm and positioning the distal end of the elongate arm adjacent the heat source in the cooking position includes actuating the telescoping structure of the elongate arm. In another implementation, the method includes periodically rotating the elongate arm about a longitudinal axis of the elongate arm after detachably coupling the top end of the stand to the elongate arm.

In yet another implementation, coupling the one or more food items to the distal end of the elongate arm includes first coupling a food attachment to the distal end of the elongate arm, wherein the one or more food items are coupled directly to the food attachment. The handle may actually be a first handle and the elongate arm may actually be a first elongate arm. The stand may then include a second handle coupled to a second elongate arm. In such an implementation, inserting the bottom end of the stand into the ground terrain includes inserting the distal end of the second elongate arm into the ground terrain. Detachably coupling the top end of the stand to the elongate arm includes detachably coupling the second handle to the first elongate arm, wherein the first handle and the first elongate arm are functionally swappable with the second handle and the second elongate arm.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the drawings, in which:

FIG. 1A is a perspective view of one embodiment of a camp cooker system in an in-hand mode;

FIG. 1B is perspective view of one embodiment of the camp cooker system in a supported mode;

FIG. 2A is a front view of one embodiment of an engagement feature on the stand of the camp cooker system;

FIG. 2B is a front view of another embodiment of the engagement feature on the stand of the camp cooker system;

FIG. 2C is a front view of another embodiment of the engagement feature on the stand of the camp cooker system;

FIG. 2D is a front view of yet another embodiment of the engagement feature on the stand of the camp cooker system;

FIG. 3 is a perspective view of one embodiment of the camp cooker system showing the elongate arm with a telescoping structure and various food attachments;

FIG. 4A is a perspective partial view of one embodiment of a receptacle and a spring coupler for detachably coupling the handle to the elongate arm;

FIG. 4B is a partial exploded view of one embodiment of the receptacle and the spring coupler;

FIG. 5A is a top perspective view of one embodiment of the receptacle;

FIG. 5B is a bottom perspective view of one embodiment of the receptacle;

FIG. 6A is a top perspective view of one embodiment of the spring coupler;

FIG. 6B is a bottom perspective view of one embodiment of the spring coupler;

FIG. 7 is a schematic flow chart diagram of one embodiment of a method for using the camp cooker system;

FIG. 8 is a bottom view of one embodiment of a food attachment that includes a wire cage;

FIG. 9 is a side view of one embodiment of the food attachment of FIG. 8;

FIG. 10 is a magnified side view of a clasp mechanism of the food attachment of FIG. 8;

FIG. 11 is a perspective view of one embodiment of the food attachment of FIG. 8; and

FIG. 12 is a rear view of one embodiment of the food attachment of FIG. 8.

### DETAILED DESCRIPTION

Reference throughout this specification to “one embodiment,” “an embodiment,” or similar language means that a particular feature, structure, or characteristic described in connection with the embodiment is included in at least one embodiment of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present disclosure, however, absent an express correlation to indicate otherwise, an implementation may be associated with one or more embodiments.

Unfortunately for many campers and other outdoor enthusiasts, currently available outdoor cooking devices are generally limited in their function, portability, and adaptability. For example, many outdoor cooking utensils are only designed to perform a single cooking procedure. In other words, many conventional cooking utensils are specifically limited to cooking a specific food or a specific food type. Additionally, many of these tools are unable to provide “hands free” cooking. Thus, users often have to continuously grasp the conventional cooking utensil the entire duration of the cooking process. Accordingly, all of these conventional cooking devices/utensils are generally inconvenient for the user to implement because the user is required to haul multiple tools, each with its own specific functionality, to the space where the user desires to cook. As mentioned above, the presently disclosed camp cooker system overcomes many of the deficiencies and shortcomings of conventional camping utensils/devices.

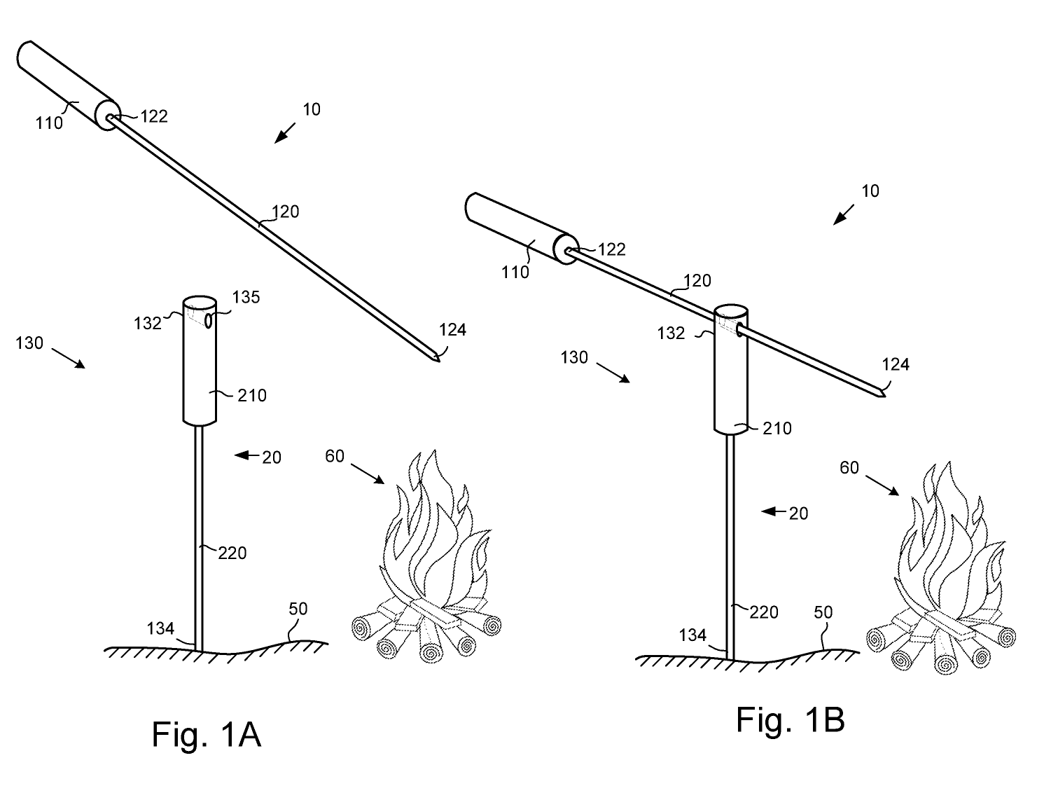

FIG. 1A is a perspective view of one embodiment of a camp cooker system in an in-hand mode. As depicted in FIG. 1A, the camp cooker system includes a cooking device 10 that has a handle 110 and an elongate arm 120. The elongate arm 120 extends from the handle 110 and a user is able couple one or more food items to a distal end 124 of the elongate arm 120, thus allowing the user to suspend the one or more food items over a heat source 60. The heat source 60, in one embodiment, may be any type of combustion driven reaction that releases heat hot enough to prepare food. For example, the heat source may be a wood-burning flame, charcoal, a propane or other gas burner, etc.

The camp cooker system may also include a stand 130 that can be engaged with a ground terrain 50 and that can be used to support the cooking apparatus 10. The stand 130 has a top end 132 and a bottom end 134. The bottom end 134 is engageable with the ground terrain 50. In other words, the bottom end 134 may be driven into the ground 50 in order to anchor and support the substantially vertical orientation of the stand 130. In another embodiment, not depicted, the stand 130 may include a ground surface interface, such as a weighted base, to which the bottom end 134 of the stand 130 is coupled, thus allowing the stand 130 to be anchored in the vertical position without requiring the bottom end 134 the stand 132 to pierce the ground 50. The camp cooker system may also include other stabilization facilitating features that promote sufficient engagement between the stand 130 the ground 50.

Referring to FIGS. 1A and 1B, the top end 132 of the stand 130 includes an engagement feature 135. The engagement feature 135 is able to be coupled to one or both of the handle 110 and the elongate arm 120 of the cooking device 10. In one specific embodiment, the engagement feature 135 is a borehole that extends through the top end 132 of the stand 130 through which the elongate arm 120 may be inserted. In such an embodiment, the stand 130 may hold and support the cooking device 10 in a desired cooking position without requiring the user to constantly grasp and/or hold the cooking device 10 in his hands. In other words, FIG. 1B shows the cooking device 10 in a “supported mode” (i.e., a “hands-free” mode).

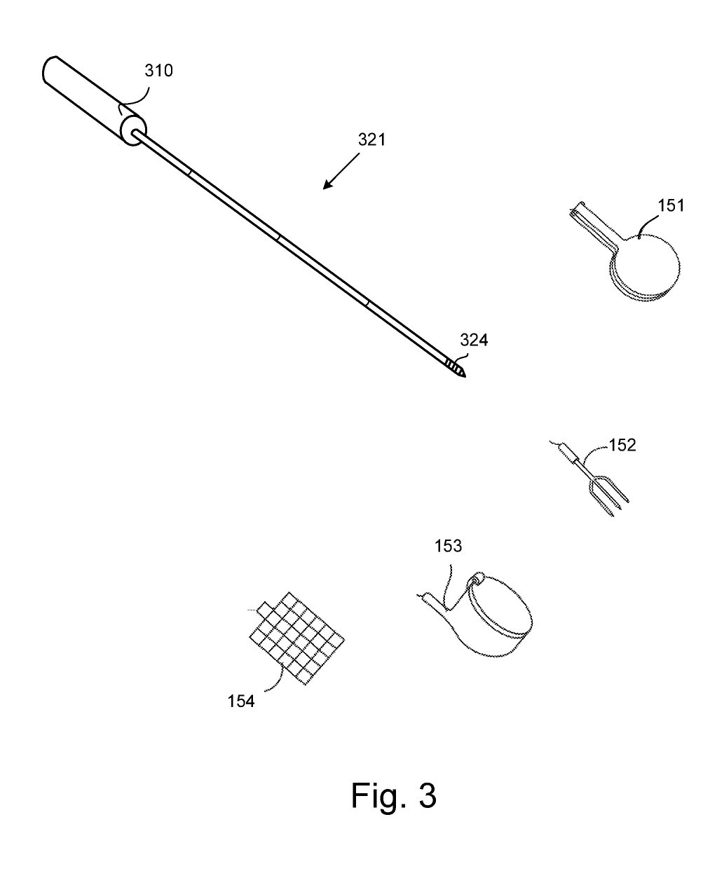

In one embodiment, the stand 130 may actually be a second cooking device 20. In other words, the user may configure two individual cooking devices so that one of the two holds the food items in the other the two is driven into the ground, for example, to support the first in a desired cooking position. Thus, the second cooking device 20 may have an elongate arm 220 coupled to a handle 210. In one embodiment, the first cooking device 10 and the second cooking device 20 may be swappable and/or interchangeable. As described below in greater detail, the cooking device of the camp cooker system may include other features and/or elements that improve the adaptability and ease-of-use of the system. In another embodiment, for example, each cooking device may include two elongate arms that are coupled to a hinging food attachment. Additional details relating to other embodiments are included below with reference the remaining figures, specifically with reference to FIG. 3.

In one embodiment, the elongate arm 120 of the cooking device 10 includes a substantially permanent attachment interface along the length of the elongate arm 120 to which the stand 130 (i.e, the engagement feature 135) maybe coupled. In other words, if the top end 132 of the stand 130 had a cylindrical cross-section, as depicted, the attachment interface affixed to the elongate arm 120 may include a corresponding cylindrical sleeve that receives the top end 132 of the stand 130.

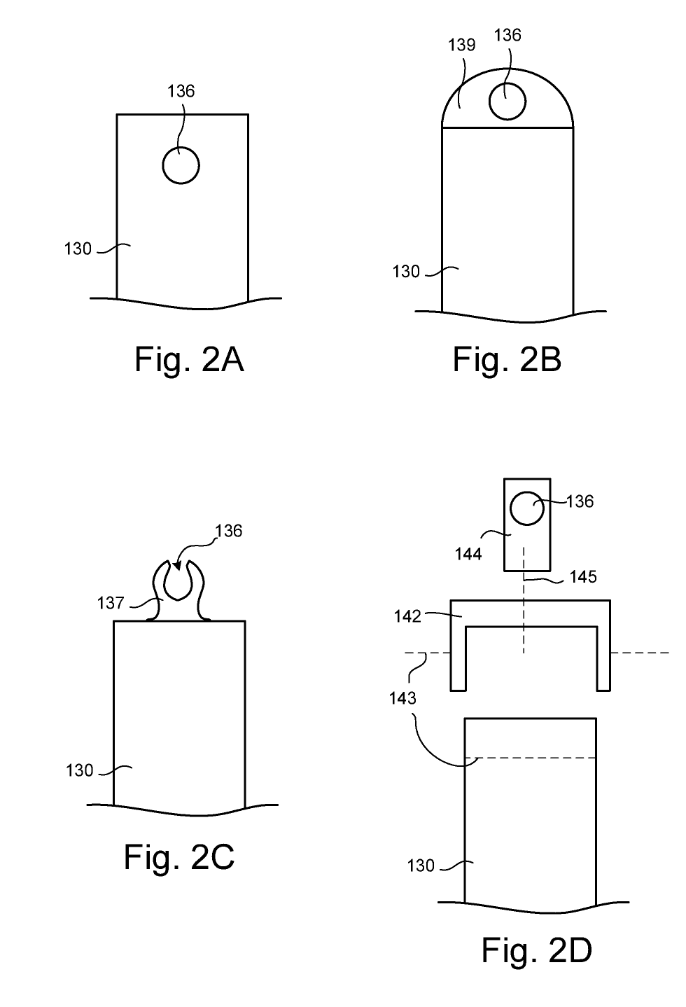

FIG. 2A is a front view of one embodiment of an engagement feature on the top end 132 of the stand 130 of the camp cooker system. As described above, the top end 132 of the stand 130 may actually be the handle 210 of a second cooking device 20. The engagement feature depicted in the top end of the stand 130 in FIG. 2A is a borehole 136 formed directly into the stand 130. The elongate arm 120 the cooking device 10 maybe inserted, or at least partially inserted, through the borehole 136 of the stand 130. In such an embodiment, a user can periodically grasp the handle 110 of the cooking device 10 and rotate the cooking device 10 about a longitudinal axis of the elongate arm 120 within the borehole 136. In other words, the user may utilize the camp cooker system to perform a rotisserie type cooking procedure.

FIG. 2B is a front view of another embodiment of the engagement feature on the stand 130 of the camp cooker system. The stand 130 may have a bracket 139 affixed to the top end with a borehole 136 extending there-through. In other words, a bracket 139 with a borehole 136 may be affixed to the stand 130 in order to maintain the structural integrity of the stand 130. For example, if the stand 130 were made of wood or other such material, depending on the size of the borehole 36 and expected weight of the cooking device 10 and the weight of the associated food items coupled thereto, repeated use of the engagement feature may cause structural failure and/or strain in the stand 130. Therefore, the attachment bracket 139, as shown in FIG. 2B, may be implemented as a engagement feature. FIG. 2C is a front view of another embodiment of the engagement feature on the stand of the camp cooker system. Similar to the embodiment described with reference to FIG. 2B, the engagement feature may be a hardware clasp or other fastener mechanism that is capable of receiving and holding the elongate shaft 120 of the cooking device 10.

FIG. 2D is a front exploded view of yet another embodiment of the engagement feature on the stand of the camp cooker system. The engagement feature, according to one embodiment, may be a more complex bracket. For example, the engagement feature may include a bracket mechanism that includes two separate portions that are rotatable with respect to each other. In other words, the bracket mechanism may include a fixed bracket 142 that is coupled to the stand 130 and a rotating bracket portion 144 that includes the borehole 136 through which at least a portion of the cooking device 10 maybe inserted. One embodiment, the fixed bracket portion 142 may be permanently affixed to the stand 130 via screws, bolts, or other fasteners along line 143. Another fastener may be implemented to couple the fixed portion 142 to the rotating bracket portion 144 a long line 145. In such a configuration, the rotating bracket portion 144 may be actuated to rotate about the fastener axis 145, thus allowing a user to selectively control the cooking position of the one or more food items coupled to the distal end 124 of the elongate arm 120. Thus, a user may be able to pivot the cooking device 10 about the top end 132 of the stand 130 in a horizontal direction.

While numerous examples are included in the figures and different embodiments are described herein in reference to the structure of the attachment between the stand 130 and the cooking device 10, it is expected others of ordinary skill in the art will recognize other mechanisms/structures that may be implemented to achieve the desired coupling between the stand 130 in the cooking device 10. These other mechanisms/structures fall within the scope of the present disclosure.

FIG. 3 is a perspective view of one embodiment of the camp cooker system showing the elongate arm having a telescoping structure 321 and various food attachments 151, 152, 153, 154 (collectively 150). As described above, the cooking device 10 maybe used and adapted for various cooking procedures. For example, the distal end 324 of the elongate arm 321 may be threaded or may include another type of quick coupling mechanism, thereby allowing a plurality of different food attachments 150 to be used in conjunction with the cooking device. In one embodiment, a first food attachment 151 may be a layered/enclosed cooking element. In another embodiment, the food attachments 150 that are capable of being connected to the distal end 324 of the elongate arm 321 include a pronged extension 152, a hinged container 153, or any enclosed wire frame 154. These attachments may further include, but are not limited to grill cooking attachments, sandwich cooking attachments (sliced bread), pie cooking attachments, cake cooking attachments, dutch oven cooking attachments, pop-corn popper attachment, foil dinner holding attachment, corn cooking attachment, meat and poultry attachment, omelet and other egg cooking attachments, liquid containing attachments (bowl), namely soup, and as many attachments to fit the specific food cooking and water boiling need as necessary.

Also as described above, the elongate arm 321 may have a telescoping structure, thereby allowing the cooking device 10 to be collapsed for storage and/or transport. In one specific embodiment, the telescoping elongate arm 321 may even be at least partially retractable within the handle 310 of the device. In another embodiment, not depicted, the cooking device may include two arms that have a long and slender configuration, and a handle that may include a wood hand grip or other material serving as the hand grip. On the end of each arm 120 the hand grips may be attached with attachment ring as commonly used with pie irons and sandwich irons or constructed with aluminum. On an opposite or distal end of the cooking device from the proximal hand grip area of each arm, there may be food holding attachment means to connect and disconnect the food holding portion of the arm. The various components of the camp cooker system may be constructed from metals (e.g., iron, aluminum), ceramics, composite materials, and or any food-grade material that is suitable to be used in high temperatures.

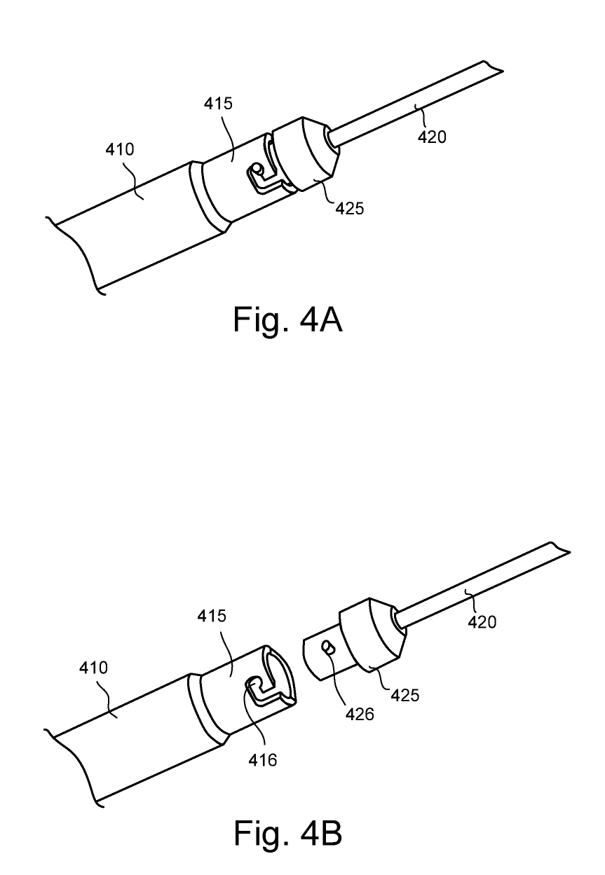

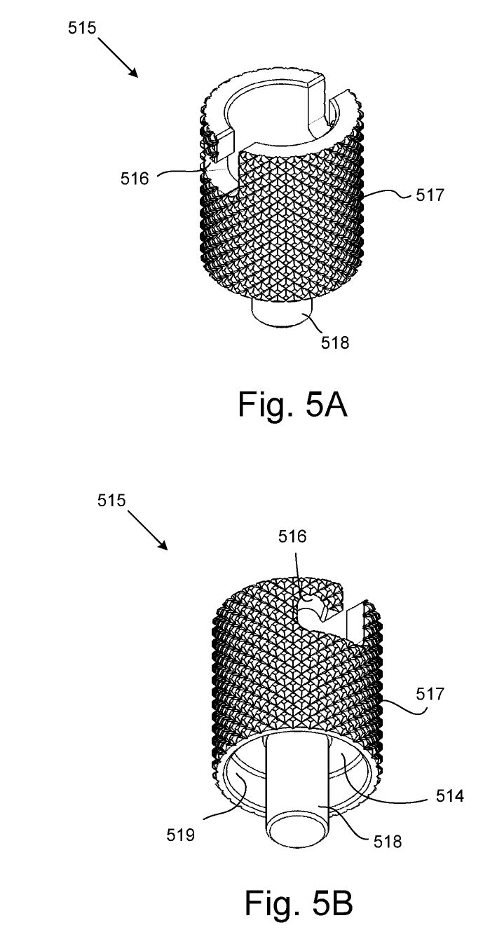

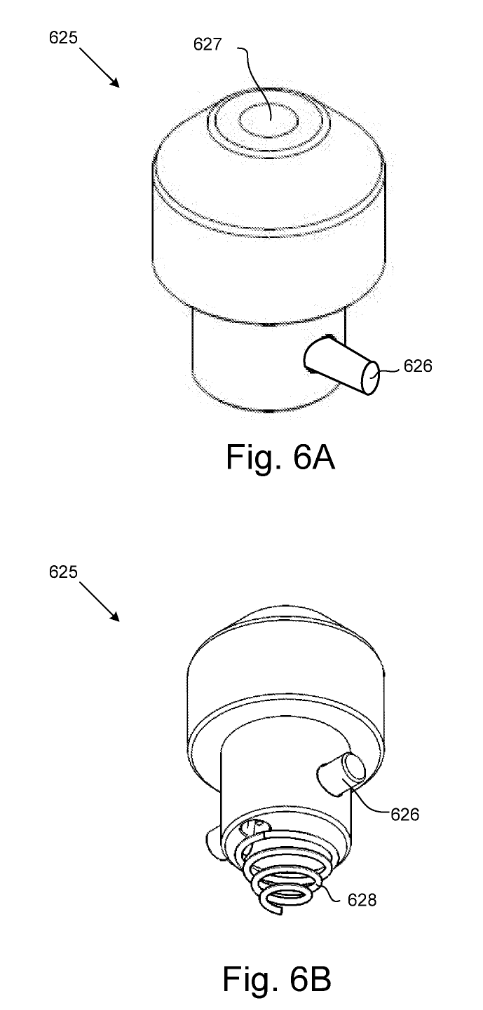

FIG. 4A is a perspective partial view of one embodiment of a receptacle 415 and a spring coupler 425 for detachably coupling the handle 410 to the elongate arm 420. FIG. 4B is a partial exploded view of the receptacle 415 and the spring coupler 425. The receptacle 415 may be permanently affixed to the handle 410 and includes a lock groove 416. The spring coupler 425, to which the elongate arm 420 is coupled, includes a lock bar 426 that corresponds in size and general dimensions as the lock groove 416. These components are described in greater detail below with reference to FIGS. 5A through 6B. Generally, the lock bar 426 of the spring coupler 425 may be inserted within the lock groove 416 and a spring mechanism integrated with the spring coupler 425 may maintain the lock bar in the locked position within the lock groove, thus ensuring that the elongate arm 420 remains coupled to the handle 410 during a desired cooking operation. Once a user has completed the cooking operation or if the user desires to swap-out the handle 410 or swap-out in elongate arm 420, a user may press the spring coupler 425 in a direction towards the handle 410, thus compressing the spring mechanism and allowing the lock bar 426 two disengage the lock groove 416.

FIG. 5A is a top perspective view of one embodiment of the receptacle 515 while FIG. 5B is a bottom perspective view of the receptacle 515. The exterior surface 517 of the receptacle 515 may include notches or knurl patterning to promote the user's grip/grasp on the device. Although not shown in previous figures, the exterior surfaces of the various components of the camp cook system may have similar notches and/or knurl patterns to promote the grip/grasp the user. For example, the handle of the cooking device may be configured to have an ergonomic shape and/or may include grip enhancing features such as rubber liners. The receptacle 515 may further include an interior shaft 518. In one embodiment, as briefly described above, the system may be configured to allow a collapsible elongate arm (i.e. telescoping structure) to be at least partially retracted within the handle itself. In such embodiment, the elongate arm may extend through the shaft 518 into the interior chamber of the handle.

The receptacle 515 also may include interior sidewalls 519 that are threaded or otherwise configured so as to be detachably coupleable with the handle. FIG. 5B shows an underside of an internal shoulder 514 of the receptacle 515. The spring mechanism 628 (see FIG. 6B) may engage the top side of this internal shoulder 514, thus causing the spring mechanism 628 to partially compress, thereby providing the force necessary to hold the lock bar(s) 626 in the locked position within the lock groove 616.

FIG. 6A is a top perspective view of one embodiment of the spring coupler 625 and FIG. 6B is a bottom perspective view of the spring coupler 625. The spring coupler 625 may include an interior channel 627 through which and to which the elongate arm is coupled. The spring mechanism 628 may be affixed to a bottom portion of the spring coupler 625 so as to be engageable with the internal shoulder 514 of the receptacle 515. In one embodiment, the elongate arm may extend through the spring coupler 625, through the receptacle 515, and at least partially into the handle. However, in other embodiments, the elongate arm may not be collapsible and/or may not be retractable within the handle. In other words, the spring mechanism 628 may have other shapes and/or general dimensions. For example, the spring mechanism may not have the form of a single cone-shaped coil, but instead may be a plurality of smaller spring coils.

In one embodiment, the female receptacle and the spring coupler are collectively referred to as the connection piece. As described above, the connection piece may be implemented between the handle and the elongate arm to allow for easy disassembly or switching out of the handle or the elongate arm. In another embodiment, the connection piece may be implemented at the other end of the elongate arm between the distal end and the food attachments.

Generally, when the connection piece is utilized at the distal end of the elongate arm, the female receptacle and the male spring coupler interlock and allow the telescopic handle to connect and disconnect providing interchangeability between the food cooking attachments. The female receptacle may fasten to and becomes a substantially permanent part of, for example, a telescoping elongate arm. The spring coupler may fasten to and becomes a permanent part of each food attachment. The receptacle may be hollow out to a specific depth to allow the partial insertion of the spring coupler. The receptacle has two opposing “J” shaped cutouts in the tube wall, with the tail/tip of the “J” forming the lock groove. The spring coupler may be drilled with a small hole through which a pin is inserted perpendicular to the longitudinal axis of the spring coupler. The pin may protrude from one or both sides of spring coupler and, when the spring coupler is pushed down into the receptacle, the lock pin is received into the “J” shaped cutouts and ultimately received into the lock groove with a slight rotation of the spring coupler. The spring mechanism of the spring coupler holds the lock pin in place within the lock groove. The connection piece design allows for quick connect and disconnect of cooking attachments even at elevated temperatures. The connection piece design is unique and meant to perform at high temperatures 700-1100 degrees Fahrenheit. Other connection technologies or designs may seize and lock up at such high temperatures.

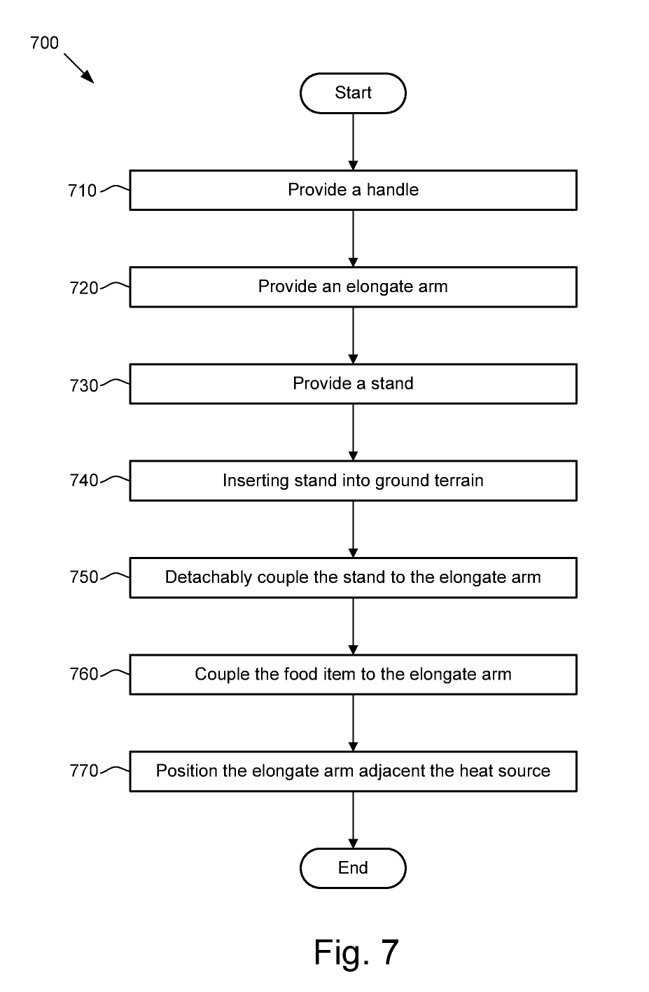

FIG. 7 is a schematic flow chart diagram of one embodiment of a method 700 for using the camp cooker system. The method 700 includes providing a handle at 710, providing an elongate arm that has a proximal end and a distal end at 720, and providing a stand with a top end and a bottom end 730. The method 700 also may include inserting the bottom end of the stand into the ground terrain at 740, detachably coupling the top end of the stand to the elongate arm at 750, coupling the one or more food items to the distal end of the elongate arm at 760, and positioning the distal end of the elongate arm adjacent the heat source in a cooking position at 770. In one embodiment, the stand is configured to support the elongate arm in the cooking position without requiring the user to exert a supporting force (i.e., “hands-free” cooking).

In another embodiment, the elongate arm has a telescoping structure for extending and retracting a length of the elongate arm and positioning the distal end of the elongate arm adjacent the heat source in the cooking position 770 includes actuating the telescoping structure of the elongate arm. In another implementation, the method includes periodically rotating the elongate arm about a longitudinal axis of the elongate arm after detachably coupling the top end of the stand to the elongate arm.

In one embodiment, coupling the one or more food items to the distal end of the elongate arm 760 includes first coupling a food attachment to the distal end of the elongate arm, wherein the one or more food items are coupled directly to the food attachment. The handle may actually be a first handle and the elongate arm may actually be a first elongate arm. The stand may then include a second handle coupled to a second elongate arm. In such an implementation, inserting the bottom end of the stand into the ground terrain 740 includes inserting the distal end of the second elongate arm into the ground terrain. Detachably coupling the top end of the stand to the elongate arm may include detachably coupling the second handle to the first elongate arm, wherein the first handle and the first elongate arm are functionally swappable with the second handle and the second elongate arm.

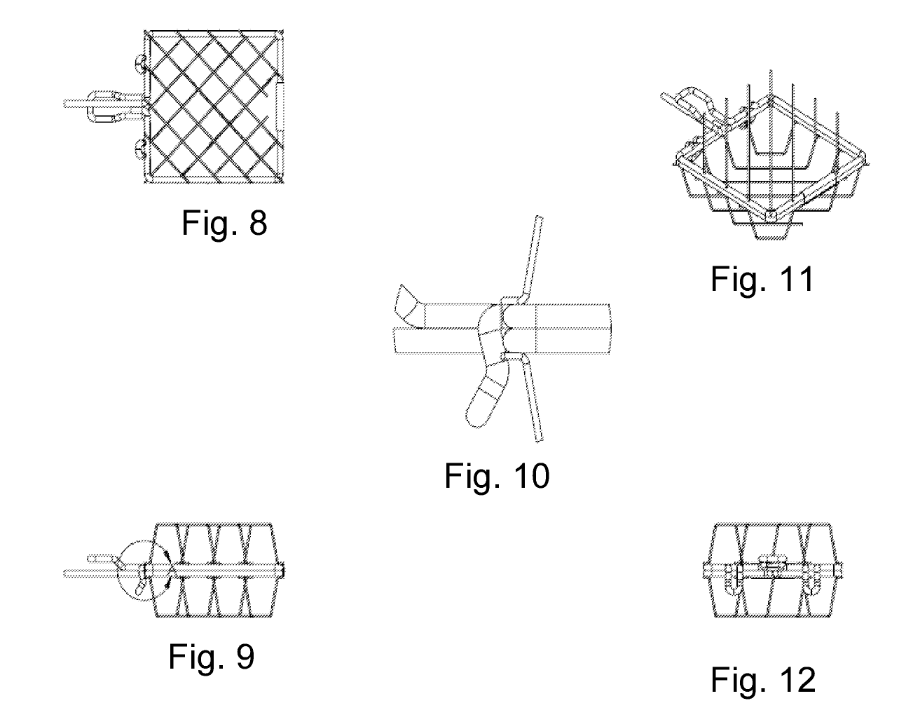

FIGS. 8-12 are various views of one embodiment of a wire cage food attachment. More specifically, FIG. 8 is a bottom view of the food attachment and FIG. 9 is a side view, FIG. 10 is a magnified side view, FIG. 11 is a perspective view, and FIG. 12 is a rear view of the embodiment of the food attachment depicted in FIG. 8. The wire cage food attachment may, for example, be used for cooking s'mores or for cooking rectangular hamburger patties. In another embodiment, the shape and general dimensions of the wire cage food attachment may vary according to the specific type of food to be cooked.

The wire cage attachment may be square in design and may have an upper and lower frame. Each frame may be a unitary structure manufactured from a single alloy wire bent in a continuous fashion to form main frames. The Upper and lower frames connect in center by a single thin metal tube wrapping around top side of both cage frames. Metal tube wrapping creates a hinge allowing cage to be opened and closed and insuring both frames are bound together. Front latching mechanism of entire cage serves to keep cage securely closed while cooking. Front latching mechanism is formed from same alloy wire by bending two small half-loop protrusion from the upper cage frame. Each protrusion extends downward with a slight bend. As upper frame closes to meet lower frame the first contact point is at each slightly bent half-loop protrusion. The slight bend creates resistance with lower frame which must be overcome in order for protrusion to overlap lower frame creating a secure closure. The continuous lower frame alloy wire bend provides extension “neck” beyond square frame where male component connector piece permanently fastens allowing interchangeability of cooking attachments with telescopic handle. The continuous upper frame alloy wire bend provides an extension “handle” beyond square frame allowing user to open and close cage. The unique s'more cage and latching mechanism design create a more secure closure with greater ease in opening/closing cage than other current designs.

In the above description, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.”

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

The present subject matter may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A camp cooker system comprising:
a handle;
an elongate arm comprising a proximal end and a distal end, wherein the proximal end is coupled to the handle and the distal end is coupleable to one or more food items to support the one or more food items adjacent a heat source; and
a stand for supporting, free of a user's supporting force, at least the distal end of the elongate arm a distance above a ground terrain, the stand comprising a top end and a bottom end, the top end detachably coupled to the elongate arm and the bottom end engageable with the ground terrain to anchor the stand.

2. The system of claim 1, wherein the elongate arm comprises a telescoping structure for extending and retracting a length of the elongate arm.

3. The system of claim 2, wherein the elongate arm is at least partially retractable within the handle.

4. The system of claim 2, wherein the proximal end of the elongate arm is detachably coupled to the handle.

5. The system of claim 3, wherein the proximal end of the elongate arm is detachably coupled to the handle.

6. The system of claim 4, wherein the handle comprises a receptacle that has a lock groove, wherein the proximal end of the elongate arm comprises a spring coupler that has a lock bar, wherein the lock bar is positionable in spring-loaded engagement with the lock groove to detachably couple the elongate arm to the handle.

7. The system of claim 5, wherein the handle comprises a receptacle that has a lock groove, wherein the proximal end of the elongate arm comprises a spring coupler that has a lock bar, wherein the lock bar is positionable in spring-loaded engagement with the lock groove to detachably couple the elongate arm to the handle.

8. The system of claim 1, further comprising a food attachment detachably coupled to the distal end of the elongate arm for supporting the one or more food items.

9. The system of claim 1, wherein the elongate arm is rotatable about a longitudinal axis of the elongate arm when the top end of the stand is coupled to the elongate arm.

10. They system of claim 1, wherein the elongate arm is pivotable in a horizontal direction about the top end of the stand when the top end of the stand is coupled to the elongate arm.

11. The system of claim 1, wherein the top end of the stand comprises an engagement feature with boreholes, wherein the elongate arm is at least partially insertable through the boreholes of the engagement feature.

12. The system of claim 1, wherein the handle is a first handle and the elongate arm is a first elongate arm, wherein the stand comprises a second handle coupled to a second elongate arm, the second handle detachably coupled to the first elongate arm and the second elongate arm engageable with the ground terrain to anchor the stand, wherein the first handle and the first elongate arm are swappable with the second handle and the second elongate arm.

13. A camp cooker apparatus comprising:
a handle comprising a receptacle that has a lock groove; and
an elongate arm comprising a proximal end and a distal end, wherein the proximal end comprises a spring coupler that has a lock bar, wherein the lock bar is positionable in spring-loaded engagement with the lock groove of the receptacle to detachably couple the elongate arm to the handle, wherein the distal end is detachably coupled to a food attachment that supports one or more food items adjacent a heat source, the elongate arm comprising a telescoping structure for extending and retracting a length of the elongate arm.

14. The camp cooker apparatus of claim 13, wherein the elongate arm is at least partially retractable within the handle.

15. A method for cooking one or more food items over a heat source, the method comprising:
providing a handle;
providing an elongate arm comprising a proximal end and a distal end, wherein the proximal end is coupled to the handle;
providing a stand comprising a top end and a bottom end;
inserting the bottom end of the stand into the ground terrain;
detachably coupling the top end of the stand to the elongate arm;
coupling the one or more food items to the distal end of the elongate arm; and
positioning the distal end of the elongate arm adjacent the heat source in a cooking position, wherein the stand supports the elongate arm in the cooking position free from a user's supporting force.

16. The method of claim 15, wherein the elongate arm comprises a telescoping structure for extending and retracting a length of the elongate arm, wherein positioning the distal end of the elongate arm adjacent the heat source in the cooking position comprises actuating the telescoping structure of the elongate arm.

17. The method of claim 15, further comprising periodically rotating the elongate arm about a longitudinal axis of the elongate arm after detachably coupling the top end of the stand to the elongate arm.

18. The method of claim 15, further comprising periodically pivoting the elongate arm in a horizontal direction about the top end of the stand.

19. The method of claim 15, wherein coupling the one or more food items to the distal end of the elongate arm comprises first coupling a food attachment to the distal end of the elongate arm, wherein the one or more food items are coupled directly to the food attachment.

20. The method of claim 15, wherein the handle is a first handle and the elongate arm is a first elongate arm, wherein the stand comprises a second handle coupled to a second elongate arm, wherein inserting the bottom end of the stand into the ground terrain comprises inserting the distal end of the second elongate arm into the ground terrain, wherein detachably coupling the top end of the stand to the elongate arm comprises detachably coupling the second handle to the first elongate arm, wherein the first handle and the first elongate arm are functionally swappable with the second handle and the second elongate arm.
